(19) United States
(12) Patent Application Publication
(10) Pub. No.: US 2026/0163018 A1
(43) Pub. Date: Jun. 11, 2026

(54) ALKALINE BATTERY

(71) Applicant: Panasonic Intellectual Property Management Co., Ltd., Kadoma-shi, Osaka (JP)

(72) Inventor: Yasuyuki Kusumoto, HYOGO KEN (JP)

(73) Assignee: Panasonic Intellectual Property Management Co., Ltd., Kadoma-shi, Osaka (JP)

(21) Appl. No.: 18/704,213

(22) PCT Filed: Oct. 21, 2022
(86) PCT No.: PCT/JP2022/039273

§ 371 Date: Apr. 24, 2024

(30) Foreign Application Priority Data
Oct. 29, 2021 (JP) 2021-178058

(51) Int. Cl. H01M 6/06; H01M 4/02; H01M 4/42

(52) U.S. Cl. CPC H01M 6/06; H01M 4/42; H01M 2004/027

(57) ABSTRACT

An alkaline dry battery includes: a positive electrode; a negative electrode; a separator that is interposed between the positive electrode and the negative electrode; and an electrolyte solution that is contained in the positive electrode, the negative electrode, and the separator. The negative electrode contains a negative electrode active material that contains zinc, a phthalic acid compound, and a gallium compound.

### TECHNICAL FIELD

The present disclosure relates to an alkaline dry battery.

### BACKGROUND ART

An alkaline dry battery (alkaline manganese dry battery) is widely used because it has a capacity larger than that of a manganese dry battery and can provide a large current.

Patent Literature 1 discloses an alkaline dry battery that includes a positive electrode, a negative electrode, a separator that is interposed between the positive electrode and the negative electrode, and an electrolyte solution that is contained in the positive electrode, the negative electrode, and the separator, wherein the electrolyte solution contains an alkaline aqueous solution, the negative electrode contains a negative electrode active material that contains zinc, and an additive, the additive contains at least one selected from the group consisting of benzoic acid, phthalic acid, isophthalic acid, and salts thereof, the amount of the negative electrode active material contained in the negative electrode is 176 to 221 parts by mass per 100 parts by mass of water contained in the electrolyte solution, and the amount of the additive contained in the negative electrode is 0.1 to 1.0 part by mass per 100 parts by mass of the negative electrode active material.

### CITATION LIST

### Patent Literature

[PTL 1] WO 2018/163485

### SUMMARY OF INVENTION

### Technical Problem

An alkaline dry battery is subjected to aging treatment by high temperature storage after the battery has been assembled in order to facilitate the flowability of the electrolyte solution in the positive electrode, detect defects caused by impurities, and the like. However, the negative electrode is usually in a gel form. For this reason, the inside of the negative electrode (negative electrode active material surface) is unlikely to be homogenized during high temperature storage, which may cause an increase in variation of internal resistance.

### Solution to Problem

One aspect of the present disclosure relates to an alkaline dry battery including: a positive electrode; a negative electrode; a separator that is interposed between the positive electrode and the negative electrode; and an electrolyte solution that is contained in the positive electrode, the negative electrode, and the separator, wherein the negative electrode contains a negative electrode active material that contains zinc, a phthalic acid compound, and a gallium compound.

### Advantageous Effects of Invention

According to the present disclosure, it is possible to reduce a variation of internal resistance of the alkaline dry battery.

Novel features of the present invention are set forth in the appended claims. However, the present invention will be well understood from the following detailed description of the present invention with reference to the drawings, in terms of both the configuration and the content together with other objects and features of the present invention.

### BRIEF DESCRIPTION OF DRAWING

FIG. 1 is a partial cross-sectional front view of an alkaline dry battery according to an embodiment of the present disclosure.

Hereinafter, an embodiment of the present disclosure will be described by way of examples. However, the present disclosure is not limited to the examples given below. In the following description, specific numerical values and materials may be listed as examples. However, other numerical values and materials may also be used as long as the advantageous effects of the present disclosure can be obtained. In the specification of the present application, the expression “a range of a numerical value A to a numerical value B” means that the range includes the numerical value A and the numerical value B, and can also be interpreted as “a numerical value A or more and a numerical value B or less”. In the following description, lower and upper limits of numerical values of specific physical properties, conditions, and the like will be shown. The lower limits and the upper limits shown below can be combined in any way as long as the lower limits are not greater than or equal to the upper limits. In the case where a plurality of materials are listed, only one material may be selected from among the plurality of materials, or a combination of two or more may be selected from among the plurality of materials.

An alkaline dry battery according to an embodiment of the present disclosure includes a positive electrode, a negative electrode, a separator that is interposed between the positive electrode and the negative electrode, and an electrolyte solution. The electrolyte solution is contained in the positive electrode, the negative electrode, and the separator. The negative electrode contains a negative electrode active material that contains zinc, and also contains a gallium compound and a phthalic acid compound as an additive. The additive contained in the negative electrode is dispersed (or dissolved) in the electrolyte solution contained in the negative electrode. In the electrolyte solution contained in the negative electrode, the gallium compound and the phthalic acid compound may be present in the form of Ga ions and phthalic acid ions.

In the case where a combination of a gallium compound and a phthalic acid compound is used as the additive contained in the negative electrode, an increase in variation of internal resistance of the battery when the battery is subjected to high temperature storage (aging treatment) after assembly is suppressed significantly. Although the detailed reason is unknown, it is assumed that Ga ions and phthalic acid ions that are present in the electrolyte solution contained in the negative electrode interact with each other on the negative electrode active material surface, which homogenizes the negative electrode active material surface during aging treatment. It is also assumed that the fact that the deposition potential of Ga is close to the potential of the negative electrode (the negative electrode active material that contains Zn) also affects the homogenization.

It is assumed that, when the gallium compound is dispersed (or dissolved) in the electrolyte solution contained in the negative electrode, Ga ions are likely to be present in the negative electrode active material surface, and thus easily interact with phthalic acid ions. It is considered that, if zinc alloy particles that contain gallium are used as the negative electrode active material, the increase in variation of internal resistance is unlikely to be suppressed. In this case, it is assumed that, because gallium is contained in the zinc alloy particles, gallium is less exposed on the particle surface, which makes the interaction with phthalic acid ions small, and thus the negative electrode active material surface is unlikely to be homogenized.

The aging treatment is performed by, for example, storing the assembled battery in an environment of 40° C. or more and 60° C. or less for 24 hours or more and 100 hours or less.

### (Gallium Compound)

The gallium compound preferably contains at least one of a gallium oxide and a gallium hydroxide. Examples of the gallium oxide include gallium oxide (Ga₂O₃) and the like. Examples of the gallium hydroxide include gallium hydroxide (Ga(OH)₃), gallium oxyhydroxide (GaOOH), and the like. In particular, it is more preferable that the gallium compound contains a gallium hydroxide, and even more preferably GaOOH. A gallium hydroxide has higher affinity for alkaline electrolyte solution (an aqueous solution of potassium hydroxide) than a gallium oxide. Gallium oxyhydroxide has a high Ga content per unit mass of the compound, and a high addition efficiency.

From the viewpoint of easily suppressing the increase in variation of internal resistance while sufficiently ensuring the packing amount of the negative electrode active material, the amount of the gallium compound contained in the negative electrode may be 0.005 parts by mass or more and 0.15 parts by mass or less (or 0.1 parts by mass or less), or 0.01 parts by mass or more and 0.06 parts by mass or less per 100 parts by mass of the negative electrode active material. It is desirable that the amount of the gallium compound is within the above-described range at the time of production of the negative electrode (immediately after assembly of the battery). Also, the gallium compound contained in the negative electrode is likely to dissolve in the electrolyte solution contained in the negative electrode, and a portion of the gallium compound contained in the negative electrode may diffuse into the positive electrode and the separator after assembly of the battery (after aging treatment). Accordingly, after assembly of the battery, the amount of the gallium compound contained in the negative electrode tends to be smaller than the above-described range. After assembly of the battery, the amount of the gallium compound contained in the negative electrode may be 0.003 parts by mass or more and 0.1 parts by mass or less per 100 parts by mass of the negative electrode active material.

From the same viewpoint, in the negative electrode, Ga/Zn that is the molar ratio of Ga derived from the gallium compound to Zn derived from the negative electrode active material may be 0.00002 or more and 0.0007 or less, or 0.00007 or more and 0.0004 or less.

The molar ratio Ga/Zn can be determined in the following manner.

First, the battery that has undergone aging treatment is disassembled to take out a portion of the negative electrode. Nitric acid is added thereto and dissolved by heating. After that, the resulting solution is allowed to cool and then filtered to remove insolubles. In this way, a sample solution is obtained. Inductively coupled plasma (ICP) emission spectroscopy analysis is performed to determine the amount of Ga and the amount of Zn in the sample solution. Then, the Ga/Zn molar ratio is calculated based on the analytical values. For the analysis, a solution obtained by diluting the sample solution with pure water and adjusting it to a constant volume is used. Also, the amount of Zn derived from ZnO in the electrolyte solution contained in the negative electrode is much smaller than the amount of Zn derived from the negative electrode active material, and thus the amount of Zn determined through the analysis can be deemed as the amount of Zn derived from the negative electrode active material.

### (Phthalic Acid Compound)

The phthalic acid compound contains phthalic acid (salt) and a derivative of phthalic acid. In the specification of the present application, the term “phthalic acid” means at least one selected from the group consisting of o-phthalic acid, p-phthalic acid (terephthalic acid), and m-phthalic acid (isophthalic acid). Examples of the derivative of phthalic acid include a derivative in which a hydrogen atom bonded to the benzene ring of phthalic acid is replaced by a halogen atom, a substituent such as an alkyl group such as a methyl group, or the like. Out of these, it is preferable to use terephthalic acid. The amount of terephthalic acid dissolved into the electrolyte solution is small, and thus the interaction with the gallium compound is relatively mild, and thus the negative electrode active material surface is likely to be homogenized.

The amount of the phthalic acid compound contained in the negative electrode may be 0.05 parts by mass or more and 0.3 parts by mass or less, or 0.05 parts by mass or more and 0.15 parts by mass or less per 100 parts by mass of the negative electrode active material. When the amount of the phthalic acid compound contained in the negative electrode is 0.05 parts by mass or more per 100 parts by mass of the negative electrode active material, the interaction with the gallium compound is likely to be exerted. When the amount of the phthalic acid compound contained in the negative electrode is 0.3 parts by mass or less per 100 parts by mass of the negative electrode active material, the electrolyte solution contained in the negative electrode is likely to have a favorable viscosity. The solubility of the phthalic acid compound in the electrolyte solution is low. Accordingly, after assembly of the battery, the phthalic acid compound contained in the negative electrode rarely migrates to the positive electrode and the separator.

In the negative electrode, the molar ratio (Ga/phthalic acid compound) of Ga derived from the gallium compound to the phthalic acid compound may be 0.06 or more (or 0.12 or more) and 2.9 or less (or 2.4 or less), 0.06 or more (or 0.12 or more) and 1.5 or less, or 0.18 or more and 0.8 or less.

The amount of the phthalic acid compound contained in the negative electrode is determined in the following manner.

(i) The battery that has undergone aging treatment is disassembled to take out the gelled negative electrode. Centrifugal separation is performed to separate the negative electrode active material, the phthalic acid compound, and the mixture of the gelling agent and the electrolyte solution from the gelled negative electrode.

(ii) The mixture obtained in the step (i) is diluted with pure water to obtain a liquid A.

(iii) The phthalic acid compound obtained in the step (i) is cleaned with pure water, and then water in which the phthalic acid compound is dispersed is filtered to obtain the phthalic acid compound and a filtrate B.

(iv) The negative electrode active material obtained in the step (i) is cleaned with pure water, and then water in which negative electrode active material is dispersed is filtered to obtain a filtrate C.

(v) The liquid A obtained in the step (ii), the filtrate B obtained in the step (iii), and the filtrate C obtained in the step (iv) are subjected to analysis based on ion chromatography to determine the total amount W1 of the phthalic acid compound (soluble) contained in the liquid A, the filtrate B, and the filtrate C.

(vi) The phthalic acid compound obtained in the step (iii) is dried to determine the amount W2 of the phthalic acid compound (insoluble).

(vii) The total amount W1 determined in the step (v) and the amount W2 determined in the step (vi) are added to obtain a sum as the amount of the phthalic acid compound contained in the negative electrode.

Hereinafter, the alkaline dry battery will be described in detail.

### (Negative Electrode)

The negative electrode usually contains a negative electrode active material, an additive (a gallium compound and a phthalic acid compound), and an electrolyte solution, and also contains a gelling agent. The negative electrode can be obtained by, for example, mixing the negative electrode active material, the additive, the gelling agent, and the electrolyte solution. The negative electrode may further contain a component other than the components described above.

As the negative electrode active material, zinc, a zinc alloy, or the like can be used. The zinc alloy may contain at least one selected from the group consisting of indium, bismuth, and aluminum from the viewpoint of corrosion resistance. The amount of indium contained in the zinc alloy is, for example, 0.01 to 0.1 mass %, and the amount of bismuth contained in the zinc alloy is, for example, 0.003 to 0.02 mass %. The amount of aluminum contained in the zinc alloy is, for example, 0.001 to 0.03 mass %. From the viewpoint of corrosion resistance, the proportion of elements other than zinc in the zinc alloy is preferably 0.025 to 0.08 mass %.

The negative electrode active material is usually used in the form of particles. From the viewpoint of ease of packing of the negative electrode and diffusibility of the electrolyte solution in the negative electrode, the negative electrode active material particles may have an average particle size of, for example, 100 μm or more and 200 μm or less, or 110 μm or more and 160 μm or less.

In the specification of the present application, the term “average particle size” refers to a median diameter (D50) in a volume-based particle size distribution. The average particle size is determined using, for example, a laser diffraction/scattering particle size distribution measurement apparatus.

As the gelling agent, a known gelling agent used in the field of alkaline dry batteries is used without a particular limitation. For example, a water-absorbent polymer or the like can be used. Examples of the gelling agent include polyacrylic acid and sodium polyacrylate. The amount of the gelling agent added is, for example, 0.5 parts by mass or more and 2.5 parts by mass or less per 100 parts by mass of the negative electrode active material.

### (Positive Electrode)

The positive electrode usually contains manganese dioxide as a positive electrode active material, a conductive agent, and an electrolyte solution. The positive electrode may further contain a binder as needed. As the manganese dioxide, it is preferable to use electrolytic manganese dioxide. The manganese dioxide is used in the form of a powder. From the viewpoint of easily ensuring ease of packing of the positive electrode, diffusibility of the electrolyte solution into the positive electrode, and the like, the manganese dioxide has an average particle size of, for example, 25 μm or more and 60 μm or less.

From the viewpoint of moldability and suppressing expansion of the positive electrode, the manganese dioxide may have a BET specific surface area of, for example, 20 m²/g or more and 50 m²/g or less. Here, the term “BET specific surface area” refers to a specific surface area determined by measuring and calculating surface area using the BET equation that is a theoretical equation for multilayer adsorption. The BET specific surface area can be determined through measurement using, for example, a specific surface area measurement apparatus based on a nitrogen adsorption method.

Examples of the conductive agent include a carbon black such as acetylene black and a conductive carbon material such as graphite. As the graphite, a natural graphite, an artificial graphite, or the like can be used. The conductive agent may be in a fibrous form or the like, but is preferably in a powder form. The conductive agent has an average particle size of, for example, 3 μm or more and 20 μm or less.

The amount of the conductive agent contained in the positive electrode is, for example, 3 parts by mass or more and 10 parts by mass or less, and preferably 5 parts by mass or more and 9 parts by mass or less relative to 100 parts by mass of the manganese dioxide.

The positive electrode can be obtained by, for example, press molding a positive electrode material mixture that contains a positive electrode active material, a conductive agent, an electrolyte solution, and optionally a binder into a pellet. The positive electrode material mixture may be made into flakes or granules and optionally classified, and then press molded into a pellet. The pellet may be housed in a battery case, and then subjected to secondary pressing using a predetermined device such that the pellet adheres to the inner wall of the battery case.

### (Separator)

Examples of the material of the separator include cellulose, polyvinyl alcohol, and the like. The separator may be a non-woven fabric composed mainly of fibers of any of the above-described materials, or may be a microporous film such as a cellophane or polyolefin film. The separator may be made of a combination of a non-woven fabric and a microporous film. Examples of the non-woven fabric include a non-woven fabric composed mainly of cellulose fibers and polyvinyl alcohol fibers, a non-woven fabric composed mainly of rayon fibers and polyvinyl alcohol fibers, and the like.

The separator has a thickness of, for example, 200 μm or more and 300 μm or less. It is preferable that the separator has a thickness within the above-described range as a whole. In the case where a sheet for forming the separator is thin, the separator may be formed by stacking a plurality of thin sheets to have a thickness within the above-described range.

### (Electrolyte Solution)

As the electrolyte solution, for example, an alkaline aqueous solution that contains potassium hydroxide is used. The concentration of potassium hydroxide in the electrolyte solution is, for example, 30 mass % or more and 50 mass % or less. The electrolyte solution may further contain zinc oxide. The concentration of zinc oxide in the electrolyte solution is, for example, 1 mass % or more and 5 mass % or less.

The alkaline dry battery according to the embodiment of the present disclosure may be a cylindrical battery, a coin-shaped battery, or the like.

Hereinafter, the alkaline dry battery according to the present embodiment will be described in detail with reference to the drawings. It is to be noted that the present disclosure is not limited to the embodiment given below. Also, modifications may be made as appropriate as long as the advantageous effects of the present invention are not impaired. Furthermore, the embodiment may also be combined with another embodiment.

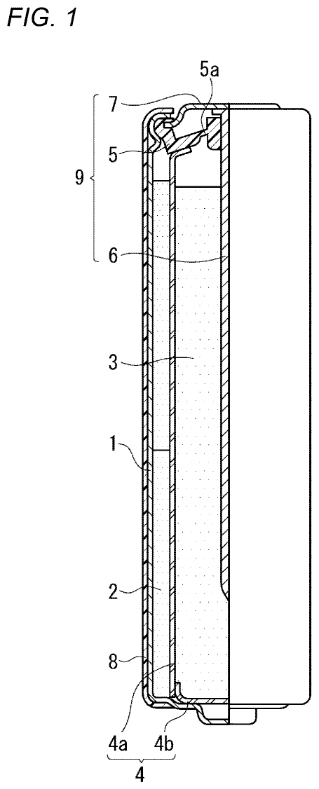

FIG. 1 is a front view of an alkaline dry battery according to an embodiment of the present disclosure, with a half of the alkaline dry battery being shown in a transverse cross section. FIG. 1 shows an example of a cylindrical battery that has an inside-out structure.

As shown in FIG. 1, the alkaline dry battery includes a hollow cylindrical positive electrode 2, a gelled negative electrode 3 provided in a hollow portion of the positive electrode 2, a separator 4 interposed between the positive electrode 2 and the negative electrode 3, and an electrolyte solution (not shown). These constituent elements are housed in a bottomed cylindrical battery case 1 that also functions as a positive electrode terminal. As the electrolyte solution, an alkaline aqueous solution is used.

The positive electrode 2 is provided in contact with an inner wall of the battery case 1. The positive electrode 2 contains manganese dioxide and an electrolyte solution. The gelled negative electrode 3 is filled in a hollow portion of the positive electrode 2 via the separator 4. The negative electrode 3 contains a negative electrode active material, an additive (a gallium compound and a phthalic acid compound), an electrolyte solution, and a gelling agent.

The separator 4 is a bottomed cylindrical separator, and contains an electrolyte solution. The separator 4 includes a cylindrical separator 4a and a paper bottom 4b. The separator 4a is provided along an inner surface of the hollow portion of the positive electrode 2, and separates the positive electrode 2 and the negative electrode 3 from each other. Accordingly, the expression “a separator that is interposed between the positive electrode and the negative electrode” means the cylindrical separator 4a. The paper bottom 4b is placed on a bottom portion of the hollow portion of the positive electrode 2, and separates the negative electrode 3 and the battery case 1 from each other.

As the battery case 1, for example, a bottomed cylindrical metal case is used. The metal case is made using, for example, a nickel-plated steel plate. In order to enhance the adhesion properties of the contact between the positive electrode and the battery case, it is preferable to use a battery case in which an inner surface of a metal case is covered with a carbon coating film.

An opening portion of the case 1 is sealed with a sealing unit 9. The sealing unit 9 includes a resin gasket 5, a negative electrode current collector 6, and a negative electrode terminal plate 7 that also functions as a negative electrode terminal. The gasket 5 has an annular thin portion 5a. When the battery internal pressure exceeds a predetermined value, the thin portion 5a is broken to release a gas to the outside of the battery. The negative electrode current collector 6 may contain, for example, copper, and may be made of an alloy of copper and zinc such as brass. A surface of the negative electrode current collector 6 may be plated with tin or the like as needed.

The negative electrode current collector 6 is inserted in the negative electrode 3. The negative electrode current collector 6 has a nail-shaped configuration that includes a head portion and a shank portion. The shank portion is inserted in a through hole formed in a center cylindrical portion of the gasket 5, and the head portion of the negative electrode current collector 6 is welded to a flat portion of the negative electrode terminal plate 7 at a center thereof. An opening end portion of the battery case 1 is crimped onto a flange portion along a circumferential edge portion of the negative electrode terminal plate 7 via an outer circumferential end portion of the gasket 5. An outer surface of the case 1 is covered with an exterior label 8.

In FIG. 1, the bottomed cylindrical separator 4 is formed using a cylindrical separator 4a and a paper bottom 4b. However, the configuration of the bottomed cylindrical separator is not limited thereto. It is also possible to use a separator with a known shape used in the field of alkaline dry batteries. The separator may be formed using one sheet. In the case where a sheet for forming the separator is thin, the separator may be formed by stacking a plurality of thin sheets. The cylindrical separator may be formed by spirally winding a thin sheet in a plurality of layers.

### EXAMPLES

Hereinafter, the present disclosure will be described specifically based on examples and comparative examples. However, the present disclosure is not limited to the examples given below.

### Example 1

An AA-size cylindrical alkaline dry battery (LR6) as shown in FIG. 1 was produced in the following procedure.

### (Production of Positive Electrode)

A mixture was obtained by mixing an electrolytic manganese dioxide powder (with an average particle size of 35 μm) as a positive electrode active material with a graphite powder (with an average particle size of 8 μm) as a conductive agent. The mass ratio between the electrolytic manganese dioxide powder and the graphite powder was set to 92.4:7.6. 1.5 parts by mass of an electrolyte solution was added to 100 parts by mass of the mixture, and the mixture was sufficiently stirred and then compression-molded into flakes to obtain a positive electrode material mixture. As the electrolyte solution, an alkaline aqueous solution containing potassium hydroxide (at a concentration of 35 mass %) and zinc oxide (at a concentration of 2 mass %) was used.

The positive electrode material mixture in the form of flakes was crushed into granules, and then classified using a 10 to 100 mesh sieve. The obtained granules were press-molded into a predetermined hollow cylindrical shape. In this way, two positive electrode pellets were produced.

### (Production of Negative Electrode)

A negative electrode active material, an electrolyte solution, a gelling agent, a phthalic acid compound, and a gallium compound were mixed to obtain a gelled negative electrode 3. As the negative electrode active material, a zinc alloy powder (with an average particle size of 130 μm) containing 0.02 mass % of indium, 0.01 mass % of bismuth, and 0.005 mass % of aluminum was used. As the electrolyte solution, the same electrolyte solution used to produce the positive electrode was used. As the gelling agent, a mixture of crosslink-branched polyacrylic acid and highly-crosslinked linear sodium polyacrylate was used. As the phthalic acid compound, terephthalic acid was used, and as the gallium compound, gallium oxyhydroxide (GaOOH) was used. The mass ratio between the negative electrode active material, the electrolyte solution, and the gelling agent was set to 100:50:1.

The amount of GaOOH contained in the negative electrode was set to 0.025 parts by mass per 100 parts by mass of the negative electrode active material. The amount of phthalic acid contained in the negative electrode was set to 0.14 parts by mass per 100 parts by mass of the negative electrode active material. Ga/Zn, which is the molar ratio of Ga derived from GaOOH to Zn derived from the negative electrode active material contained in the negative electrode, was 0.00016. Ga/terephthalic acid, which is the molar ratio of Ga derived from GaOOH to terephthalic acid, was 0.29.

### (Assembly of Alkaline Dry Battery)

A carbon coating film with a thickness of about 10 μm was formed on the inner surface of a bottomed cylindrical case (with an outer diameter of 13.80 mm and a height of 50.3 mm) formed using a nickel-plated steel plate. In this way, a battery case 1 was obtained. Two positive electrode pellets were longitudinally inserted into the battery case 1, and then pressed to form a positive electrode 2, with the pellets adhering to the inner wall of the battery case 1. A bottomed cylindrical separator 4 was placed within the positive electrode 2. Then, an electrolyte solution was injected to impregnate the separator 4 with the electrolyte solution. As the electrolyte solution, the same electrolyte solution used to produce the positive electrode was used. The whole was left to stand in this state for a predetermined period of time to allow the electrolyte solution to permeate into the positive electrode 2 from the separator 4. After that, a predetermined amount of the gelled negative electrode 3 was filled into the separator 4.

The separator 4 was formed using a cylindrical separator 4a and a paper bottom 4b. As the cylindrical separator 4a and the paper bottom 4b, a non-woven fabric sheet composed mainly of rayon fibers and polyvinyl alcohol fibers mixed at a mass ratio of 1:1 was used. The non-woven fabric sheet used as the paper bottom 4b had a thickness of 0.27 mm. As the separator 4a, a triple-wound separator formed by winding a 0.09 mm-thick non-woven fabric sheet in three layers was used.

A negative electrode current collector 6 was obtained by pressing ordinary brass into a nail shape, and then plating its surface with tin. A negative electrode terminal plate 7 made of a nickel-plated steel plate was electrically welded to the head portion of the negative electrode current collector 6. After that, the shank portion of the negative electrode current collector 6 was press fitted in a through hole of a resin gasket 5 formed at a center thereof. In this way, a sealing unit 9 composed of the gasket 5, the negative electrode terminal plate 7, and the negative electrode current collector 6 was produced.

Next, the sealing unit 9 was provided in an opening portion of the battery case 1. At this time, the shank portion of the negative electrode current collector 6 was inserted into the negative electrode 3. The opening end portion of the battery case 1 was crimped onto a circumferential edge portion of the negative electrode terminal plate 7 via the gasket 5, and the opening portion of the battery case 1 was thereby sealed. The outer surface of the case 1 was covered with an exterior label 8. In this way, an alkaline dry battery (battery A1) was produced. The battery A1 was subjected to the following evaluation.

### [Evaluation]

Ten assembled batteries A1 were prepared, and AC resistance (mΩ) was measured at a frequency of 1 kHz in an environment of 25° C. The difference between the maximum value and the minimum value of the measured values obtained at this time was determined as the variation of internal resistance after assembly.

After that, the ten batteries A1 were stored at 45° C. for 3 days for aging treatment. AC resistance was measured in the same manner for each of the ten batteries A1 that had undergone aging treatment, and the difference between the maximum value and the minimum value of the measured values was determined as the variation of internal resistance after aging treatment.

### Comparative Example 1

A battery B1 was produced and evaluated in the same manner as the battery A1, except that terephthalic acid was not added in the production of the negative electrode.

### Comparative Example 2

A battery B2 of Comparative Example 2 was produced and evaluated in the same manner as the battery A1, except that gallium oxyhydroxide was not added in the production of the negative electrode.

### Comparative Example 3

A battery B3 of Comparative Example 3 was produced and evaluated in the same manner as the battery A1, except that terephthalic acid and gallium oxyhydroxide were not added in the production of the negative electrode.

The results of evaluation are shown in Table 1. Each of the amount of GaOOH and the amount of terephthalic acid shown in each table is an amount (part by mass) per 100 parts by mass of the negative electrode active material.

TABLE 1

| | Negative electrode | | Variation of internal | |
|---|---|---|---|---|
| | Amount of | Amount of | resistance (mΩ) | |
| | GaOOH | terephthalic acid | After | After aging |
| | (part by mass) | (part by mass) | assembly | treatment |
| A1 | 0.025 | 0.14 | 5 | 5 |
| B1 | 0.025 | 0 | 6 | 10 |
| B2 | 0 | 0.14 | 6 | 10 |
| B3 | 0 | 0 | 8 | 10 |

In the battery A, even after aging treatment, the variation of internal resistance was as low as that after assembly (before aging treatment), and the increase in the variation of internal resistance after aging treatment was suppressed significantly.

In the batteries B1 and B2, the variation of internal resistance after aging treatment increased. In the battery B3, the variation of internal resistance increased both after assembly and after aging treatment.

It can be seen that, in the battery B1 in which only a gallium compound was used and the battery B2 in which only a phthalic acid compound was used, the variation of internal resistance after aging treatment increased to the same level as in the battery B3 (B3→B1, B3→B2).

### Example 2 to 4

Each of batteries A2 to A4 of Examples 2 to 4 was produced and evaluated in the same manner as the battery A1, except that the amount of GaOOH contained in the negative electrode was changed to a value shown in Table 2 in the production of the negative electrode. In the batteries A1 to A4, the molar ratio (Ga/Zn) of Ga derived from GaOOH to Zn derived from the negative electrode active material contained in the negative electrode was set to 0.00003 to 0.00064. The molar ratio (Ga/terephthalic acid) of Ga derived from GaOOH to terephthalic acid was set to 0.06 to 1.16. The results of evaluation are shown in Table 2 together with the results of the battery A1.

TABLE 2

| | Negative electrode | | Variation of internal | |
|---|---|---|---|---|
| | Amount of | Amount of | resistance (mΩ) | |
| | GaOOH | terephthalic acid | After | After aging |
| | (part by mass) | (part by mass) | assembly | treatment |
| A2 | 0.005 | 0.14 | 6 | 5 |
| A3 | 0.010 | 0.14 | 4 | 4 |
| A1 | 0.025 | 0.14 | 5 | 5 |
| A4 | 0.100 | 0.14 | 4 | 4 |

In the batteries A1 to A4, the variation of internal resistance after aging treatment was reduced significantly, which was almost as low as the variation of internal resistance after assembly.

### INDUSTRIAL APPLICABILITY

The alkaline dry battery according to the present disclosure is suitably used as, for example, a power source for a portable audio appliance, an electronic game machine, electric lighting equipment, or the like.

The present invention has been described in terms of the presently preferred embodiment, but the disclosure should not be interpreted as limiting. Various alterations and modifications will no doubt become apparent to those skilled in the art to which the present invention pertains, after having read the disclosure. Accordingly, it is to be understood that the appended claims be interpreted as covering all alterations and modifications which fall within the true spirit and scope of the present invention.

### REFERENCE SIGNS LIST

1: battery case
2: positive electrode
3: negative electrode
4: bottomed cylindrical separator
4a: cylindrical separator
4b: paper bottom
5: gasket
5a: thin portion
6: negative electrode current collector
7: negative electrode terminal plate
8: exterior label
9: sealing unit

1. An alkaline dry battery comprising:
a positive electrode;
a negative electrode;
a separator that is interposed between the positive electrode and the negative electrode; and
an electrolyte solution that is contained in the positive electrode, the negative electrode, and the separator,
wherein the negative electrode contains a negative electrode active material that contains zinc, a phthalic acid compound, and a gallium compound.

2. The alkaline dry battery in accordance with claim 1,
wherein the gallium compound contains at least one of a gallium oxide and a gallium hydroxide.

3. The alkaline dry battery in accordance with claim 2,
wherein the gallium compound contains gallium oxyhydroxide.

4. The alkaline dry battery in accordance with claim 1,
wherein the amount of the gallium compound contained in the negative electrode is 0.005 parts by mass or more and 0.1 parts by mass or less per 100 parts by mass of the negative electrode active material.

5. The alkaline dry battery in accordance with claim 1,
wherein the phthalic acid compound contains at least one selected from the group consisting of o-phthalic acid, isophthalic acid, and terephthalic acid.

6. The alkaline dry battery in accordance with claim 5,
wherein the phthalic acid compound contains terephthalic acid.

7. The alkaline dry battery in accordance with claim 1,
wherein the amount of the phthalic acid compound contained in the negative electrode is 0.05 parts by mass or more and 0.3 parts by mass or less per 100 parts by mass of the negative electrode active material.
